(19) United States
(12) Patent Application Publication
(10) Pub. No.: US 2004/0243918 A1
(43) Pub. Date: Dec. 2, 2004

(54) Method and apparatus for emphasizing selected text in a messaging session

(75) Inventors: Corradino D. Jones, Pflugerville, TX (US); Basu Vaidyanathan, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY (US)

(21) Appl. No.: 10/447,840

(22) Filed: May 29, 2003

(51) Int. Cl. G06F 11/10; G08B 5/22

(52) U.S. Cl. 714/807; 340/7.52

(57) ABSTRACT

A method, apparatus, and computer instructions for managing messages. A message is received during a messaging session. Responsive to receiving the message, a determination is made as to whether a particular string in the message matches a selected string. Responsive to the particular string matching the selected string, a display of the string with a selected type of emphasis is caused. The displaying of the text with the emphasis occurs dynamically during the messaging session.

### BACKGROUND OF THE INVENTION

1. Technical Field

The present invention relates generally to an improved data processing system and in particular to a method, apparatus, and computer instructions for processing data. Still more particularly, the present invention provides a method, apparatus, and computer instructions for managing messages sent during a messaging session.

2. Description of Related Art

Instant messaging is an online chat medium, allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often used by users conducting business. By utilizing instant messaging, business users can view each other's availability and initiate a text conversation with colleagues or customers when a desired contact becomes available. Millions of users communicate using instant messaging systems every day. With instant messaging becoming an important part of both personal and business communications, functionality and usability enhancements are important to the continued success of this type of communication tool.

Typically, instant messaging occurs between two parties while a chat session occurs between three or more parties. In either case, oftentimes different topics are discussed during the messaging session. With two parties, it is sometimes difficult to focus on a particular subject when one or both parties to this session are introducing new topics. Further, responses to a topic may occur during the discussion of another topic. When three or more parties are present in a messaging session, many topics are often being discussed in which some parties may only participate in a subset of those topics.

Oftentimes, a party may be interested only in a particular topic or in a question directed directly towards that party. The party interested in a particular topic or question is required to scroll up or down the screen to identify messages relating to the topic or question of interest. Such a task can be frustrating when many messages have been exchanged and many different topics are being discussed during the messaging session.

Therefore, it would be advantageous to have an improved method, apparatus, and computer instructions for managing messages occurring during a messaging session.

### SUMMARY OF THE INVENTION

The present invention provides a method, apparatus, and computer instructions for managing messages. A message is received during a messaging session. Responsive to receiving the message, a determination is made as to whether a particular string in the message matches a selected string. Responsive to the particular string matching the selected string, a display of the string with a selected type of emphasis is caused. The displaying of the text with the emphasis occurs dynamically during the messaging session.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are diagrams illustrating the flow of messages between client applications in a messaging session in accordance with a preferred embodiment of the present invention;

FIG. 5 is an example of a keyword table in accordance with a preferred embodiment of the present invention;

FIG. 6 is a diagram of a messaging window in a messaging client in accordance with a preferred embodiment of the present invention;

FIG. 7 is a flowchart of a process for defining a keyword and an associated emphasis in accordance with a preferred embodiment of the present invention; and

FIG. 8 is a flowchart of a process for handling messages in accordance with a preferred embodiment of the present invention.

### DETAILED DESCRIPTION OF THE PREFERRED EMBODIMENT

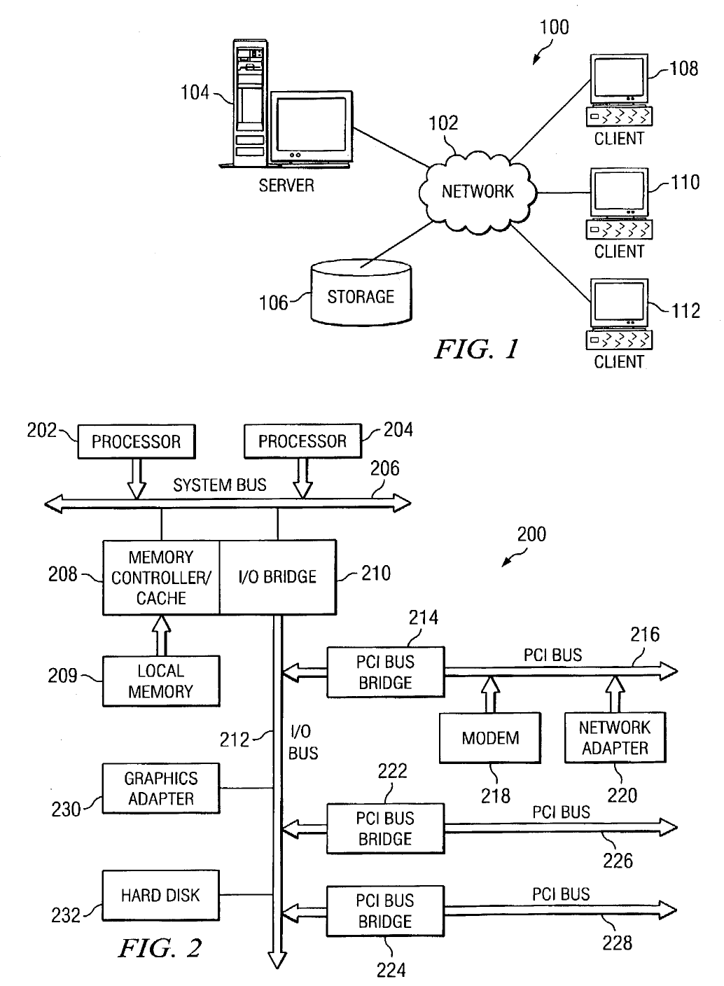

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Specifically, server 104 may act as a messaging server to facilitate the transfer of messages between clients 108, 110, and 112. Depending on the particular implementation, server 104 may act only to provide an identification of addresses for the clients to send messages to each other directly. In other implementations, server 104 may act as a conduit through which all the messages may flow. In this type of implementation, the clients do not send messages to other clients, but send them to server 104, which in turn sends them to the appropriate client.

Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

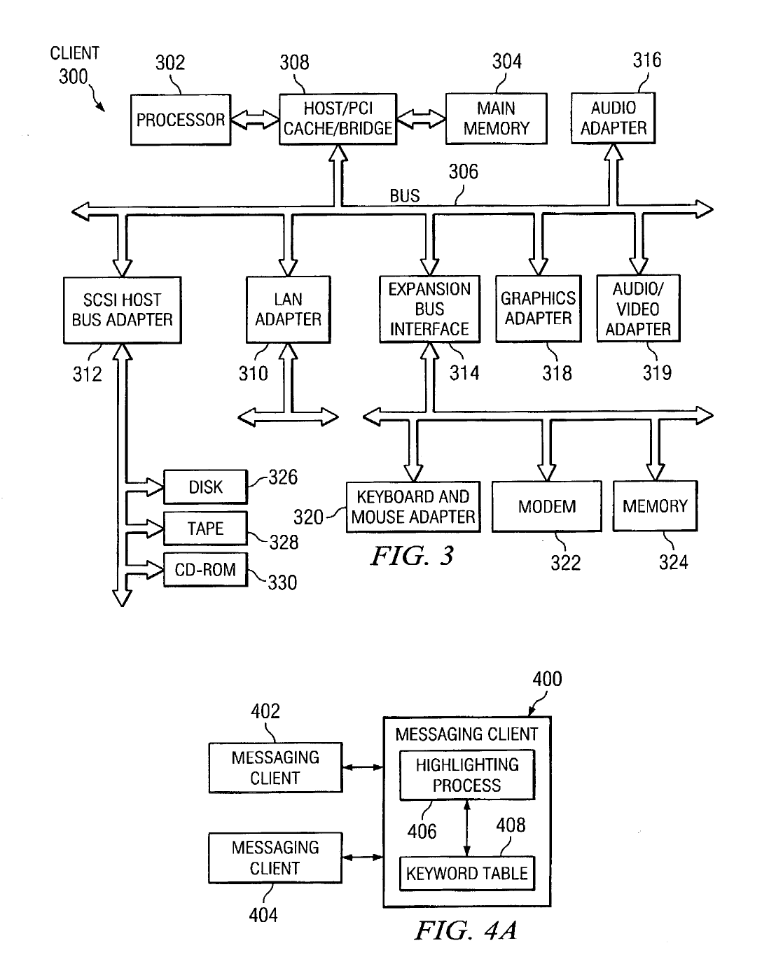

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

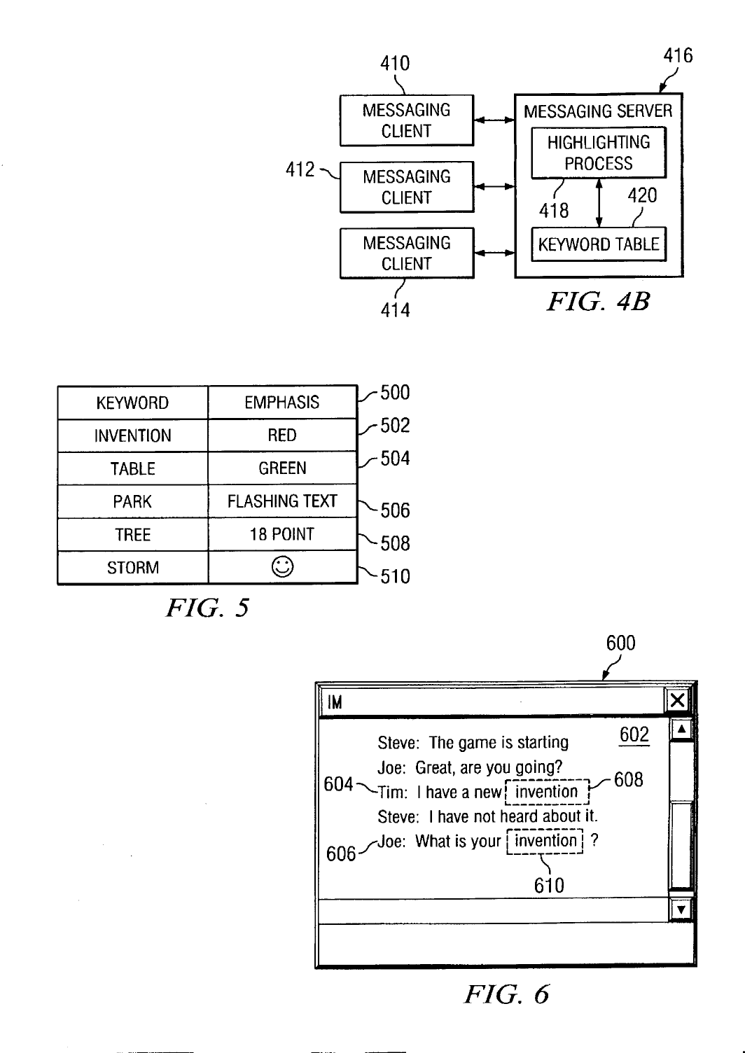

With reference now to FIGS. 4A and 4B, diagrams illustrating the flow of messages between client applications in a messaging session are depicted in accordance with a preferred embodiment of the present invention. In FIG. 4A, messaging client 400 exchanges messages with messaging client 402 and messaging client 404. These messaging clients may be implemented using a data processing system, such as data processing system 300 in FIG. 3.

In this example, messaging client 400 sends and receives messages directly with respect to messaging client 402 and messaging client 404 without requiring a server to exchange messages during the messaging session. In this type of implementation, the messaging server serves as a location or source to identify other users and to obtain addresses of users to establish messaging sessions.

Messaging client 400 includes highlighting process 406, which is used to highlight portions of a message or all of a message in which selected text is found. If the user is interested in a particular topic, the user may identify one or more keywords that will be found in a message relating to the particular topic. The keyword or keywords may be stored in keyword table 408. When a message is received from a messaging client, such as messaging client 402 or 404, any keyword or keywords in keyword table 408 are used while the message is parsed to determine whether those keywords are present in the received message. If a keyword is present in the received message, the message is presented or displayed to the user with an emphasis. This emphasis may take various forms.

For example, each keyword may be associated with a particular color. If the keyword is present in a message, that message may be displayed using the color associated with the keyword. Additionally, the entire message may be displayed using the entire color. If more than one keyword with different color coding is present in the message, each keyword may be displayed using the color associated with the keyword in the message. Alternatively, an alternate color may be used to indicate that more than one keyword is present in the message. As a further illustration, messages may be color coded by keyword and particular participants. For example, a keyword is highlighted only if a particular person uses the keyword. Also, an entire message containing a keyword may be highlighted with the keyword having a different emphasis or highlighting. These and other types of emphasis may be made, for example, by changing or adding tags in the message for the appropriate emphasis.

Another type of emphasis that may be used includes, for example, flashing text, underlined text, bold text, and italicized text. Additionally, a graphical indicator may be displayed in association with the message if a keyword is present. The emphasis in presentation may be audio in addition to or in place of a visual emphasis. For example, if a cursor is positioned over a message containing a keyword, an audio emphasis, such as a chime or other sound, may be presented to the user.

In FIG. 4B, messaging client 410, messaging client 412, and messaging client 414 exchange messages with one another through messaging server 416. In this example, messaging server 416 acts as a conduit for all messages exchanged between these messaging clients. In other words, any message sent from messaging client 410 to messaging client 412 or messaging client 414 passes through messaging server 416. Direct messaging does not occur in this example. As a result, the messaging clients do not need to know the IP addresses of the other messaging clients.

With this type of messaging architecture, messaging server 416 may provide the message handling processes of the present invention. Messaging server 416 may be implemented using a data processing system, such as data processing system 200 in FIG. 2. Highlighting process 418 and keyword table 420 are located within messaging server 416. With this type of implementation, keyword table 420 contains keywords defined by users at messaging client 410, messaging client 412, and messaging client 414. Additionally, with a messaging server parsing keywords, each client has its own keyword table and all of these tables are communicated to the messaging server 416 if this server is going to process each client's message. The processed messages are communicated back to each client respectively. Also, any update to the keyword table is dynamically communicated to messaging server 416 as well.

For example, if the user at messaging client 410 has defined “invention” as a keyword, messaging server 416 will parse all messages directed towards messaging client 410 to see whether this keyword is present. If the keyword is present, an appropriate emphasis is applied to the message to emphasize the keyword or the message. The emphasis may be, for example, a tag that changes the color of the font to the color associated with the keyword. The tag may be placed before and after the keyword or around the entire message. In a similar fashion, keywords defined by users at the other messaging clients may be parsed by highlighting process 418 and modified to provide an emphasis as keywords are identified in messages.

In FIG. 4B, highlighting process 418 is located in messaging server 416. Even though this example requires a messaging server as a conduit for the messages, the highlighting processes may be implemented within the messaging clients.

Turning next to FIG. 5, an example of a keyword table is depicted in accordance with a preferred embodiment of the present invention. Keyword table 500 may be implemented in keyword table 408 in FIG. 4A. In this example, keyword table 500 contains entries 502, 504, 506, 508, and 510. Each entry includes a keyword and emphasis.

For example, in entry 502, the keyword is “invention” and the emphasis is red as a font color. In entry 504, the keyword is “table”, with the emphasis being a font color equal to green. In entry 506, the keyword is “park” and the emphasis is flashing text. In entry 508, the keyword is “tree” and the associated emphasis is an 18-point font. In entry 510, the keyword is “storm”, with a graphical indicator used as the emphasis.

Turning next to FIG. 6, a diagram of a messaging window in a messaging client is depicted in accordance with a preferred embodiment of the present invention. Window 600 includes messages in section 602. In this example, the keyword is “invention”. Messages 604 and 606 contain this keyword. The mechanism of the present invention provides an emphasis defined for the keyword in response to this keyword being present in the message. In this example, dotted lines 608 and 610 encompass the keywords. Of course, this emphasis could encompass the entire message, depending on the implementation. Further, other types of emphasis may be used to emphasize the keyword or the messages in the manner described above and in other ways known to those of ordinary skill in the art.

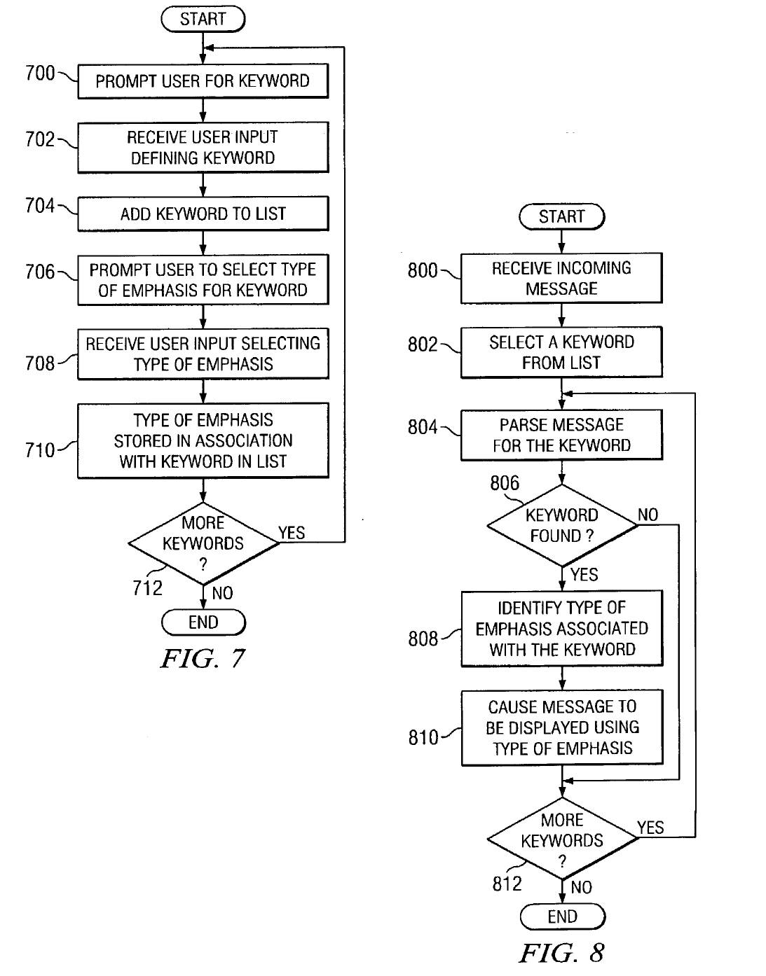

Turning now to FIG. 7, a flowchart of a process for defining a keyword and an associated emphasis is depicted in accordance with a preferred embodiment of the present invention. The process illustrated in FIG. 7 may be implemented in a highlighting process, such as highlighting process 406 in FIG. 4B.

The process begins by prompting a user for a keyword (step 700). Thereafter, user input defining the keyword is received (step 702). The keyword received and the user input is added to a keyword list (step 704). This list is a list similar to keyword list 500 in FIG. 5. The user is then prompted to select the type of emphasis for the keyword (step 706). In response, user input is received selecting the type of emphasis (step 708). This type of emphasis is stored in association with the keyword in the keyword list (step 710).

A determination is then made as to whether more keywords are to be defined (step 712). If more keywords are to be defined, the process returns to step 700 as described above. Otherwise, the process terminates.

Turning now to FIG. 8, a flowchart of a process for handling messages is depicted in accordance with a preferred embodiment of the present invention. The process illustrated in FIG. 8 may be implemented in a highlighting process, such as highlighting process 406 in FIG. 4B.

The process begins by receiving an incoming message (step 800). A keyword is selected from the list of keywords (step 802). The message is parsed to determine whether the keyword is present (step 804). A determination is made as to whether the keyword is found in the message (step 806). If the keyword is found, a type of emphasis associated with the emphasis is identified (step 808). The message is caused to be displayed using the type of emphasis identified (step 810).

A determination is then made as to whether more keywords are present for parsing in the keyword list (step 812). If additional keywords are present, the process returns to step 804, otherwise the process terminates. Turning back to step 806, if a keyword is not found, the process proceeds to step 812 as previously described.

In this example, multiple keywords may be defined. In such a case, the emphasis is typically applied to the keywords rather than the entire message.

Thus, the present invention provides an improved method, apparatus, and computer instructions for managing messages in a messaging session. The mechanism of the present invention allows for selected text or entire messages to be emphasized for easy reference by a user. This emphasis occurs dynamically during the messaging session, with the emphasis being applied as the messages are received prior to the display of the messages. If a keyword is found in the message, an emphasis associated with the keyword is applied to the keyword in the message or to the entire message. In this manner, a user may identify topics of interest from other topics that may be discussed during a messaging session.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing messages, the method comprising:
receiving a message during a messaging session;
responsive to receiving the message, determining whether a particular string in the message matches a selected string; and
responsive to the particular string matching the selected string, causing a display of the string with a selected type of emphasis, wherein the displaying occurs dynamically during the messaging session.

2. The method of claim 1, wherein the receiving, determining, and causing steps are executed by one of a client messaging program or a server messaging program.

3. The method of claim 1 further comprising:
responsive to the particular string matching the selected string, displaying the message using the selected type of emphasis.

4. The method of claim 3, further comprising:
responsive to the particular string matching the selected string, highlighting the string.

5. The method of claim 1 further comprising:
determining whether the particular message matches another selected string; and
responsive to the particular string matching another selected string, displaying the string using another type of emphasis different from the selected type of emphasis.

6. The method of claim 1, wherein the selected type of emphasis includes at least one of a particular color, bold text, italicized text, underlined text, a selected font type, a selected font size, flashing text, and audio presentation, and a graphical indicator.

7. The method of claim 1, wherein the selected string is a keyword.

8. The method of claim 1, wherein the message is displayed in association with a user name of a user originating the message and further comprising:
causing a display of the user name using the selected type of emphasis.

9. A method in a data processing system for emphasizing selected strings in messages presented in a messaging program, the method comprising:
receiving a message during a session with a remote messaging program;
responsive to receiving the message, determining whether a string in the message matches a selected string from a set of strings, wherein each string in the set of strings is associated with a different color; and
responsive to a string in the message matching the selected string, causing the string to be displayed in a color associated with the selected string.

10. The method of claim 9, wherein the method is located in one of the client messaging programs or a messaging server.

11. The method of claim 9 further comprising:
responsive to the string matching the selected string, displaying the message in the color associated with the selected string.

12. A data processing system for managing messages, the method comprising:
receiving means for receiving a message during a messaging session;
determining means, responsive to receiving the message, for determining whether a particular string in the message matches a selected string; and
causing means, responsive to the particular string matching the selected string, for causing a display of the string with a selected type of emphasis, wherein the displaying occurs dynamically during the messaging session.

13. The data processing system of claim 12, wherein the receiving means, determining means, and causing means are initiated by one of a client messaging program or a server messaging program.

14. The data processing system of claim 12 further comprising:
displaying means, responsive to the particular string matching the selected string, for displaying the message using the selected type of emphasis.

15. The data processing system of claim 14, further comprising:
highlighting means, responsive to the particular string matching the selected string, for highlighting the string.

16. The data processing system of claim 12, wherein the determining means is a first determining means and further comprising:
second determining means for determining whether the particular message matches another selected string; and
displaying means, responsive to the particular string matching another selected string, for displaying the string using another type of emphasis different from the selected type of emphasis.

17. The data processing system of claim 12, wherein the selected type of emphasis includes at least one of a particular color, bold text, italicized text, underlined text, a selected font type, a selected font size, flashing text, an audio presentation, and a graphical indicator.

18. The data processing system of claim 12, wherein the selected string is a keyword.

19. The data processing system of claim 12, wherein the causing means is a first causing means and wherein the message is displayed in association with a user name of a user originating the message and further comprising:
second causing means for causing a display of the user name using the selected type of emphasis.

20. A data processing system for emphasizing selected strings in messages presented in a messaging program, the data processing system comprising:
receiving means for receiving a message during a session with a remote messaging program;
determining means, responsive to receiving the message, for determining whether a string in the message matches a selected string from a set of strings, wherein each string in the set of strings is associated with a different color; and
causing means, responsive to a string in the message matching the selected string, for causing the string to be displayed in a color associated with the selected string.

21. The data processing system of claim 20, wherein the method is located in one of the client messaging programs or a chat server.

22. The data processing system of claim 20 further comprising:
displaying means, responsive to the string matching the selected string, for displaying the message in the color associated with the selected string.

23. A data processing system for managing messages, the data processing system comprising:
a bus system;
a memory connected to the bus system, wherein the memory includes a set of instructions; and
a processing unit connected to the bus system, wherein the processing unit executes the set of instructions to receive a message during a messaging session; determine whether a particular string in the message matches a selected string in response to receiving the message; and cause a display of the string with a selected type of emphasis in response to the particular string matching the selected string, wherein the displaying occurs dynamically during the messaging session.

24. A data processing system for emphasizing selected strings in messages presented in a messaging program, the data processing system comprising:
a bus system;
a memory connected to the bus system, wherein the memory includes a set of instructions; and
a processing unit connected to the bus system, wherein the processing unit executes the set of instructions to receive a message during a session with a remote messaging program; determine whether a string in the message matches a selected string from a set of strings in response to receiving the message, wherein each string in the set of strings is associated with a different color; and cause the string to be displayed in a color associated with the selected string in response to a string in the message matching the selected string.

25. A computer program product in a computer readable medium for managing messages, the computer program product comprising:
first instructions for receiving a message during a messaging session;
second instructions, responsive to receiving the message, for determining whether a particular string in the message matches a selected string; and
third instructions, responsive to the particular string matching the selected string, for causing a display of the string with a selected type of emphasis, wherein the displaying occurs dynamically during the messaging session.

26. A computer program product in a computer readable medium for emphasizing selected strings in messages presented in a messaging program, the computer program product comprising:
first instructions for receiving a message during a session with a remote message program;
second instructions, responsive to receiving the message, for determining whether a string in the message matches a selected string from a set of strings, wherein each string in the set of strings is associated with a different color; and
third instructions, responsive to a string in the message matching the selected string, for causing the string to be displayed in a color associated with the selected string.
